(19) United States
(12) Patent Application Publication
(10) Pub. No.: US 2012/0098760 A1
(43) Pub. Date: Apr. 26, 2012

(54) TOUCH SENSITIVE ELECTRONIC DEVICE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/979,371

(22) Filed: Dec. 28, 2010

(30) Foreign Application Priority Data
Oct. 22, 2010 (TW) 99136043

(51) Int. Cl. G09G 3/18; G06F 3/041

(52) U.S. Cl. 345/173; 345/50

(57) ABSTRACT

A touch sensitive electronic device includes an LCD panel and a touch panel arranged over the LCD panel. The touch panel includes a first touch area and a second touch area, and the first touch area and the second touch area have different touch sensitivity.

### BACKGROUND

1. Technical Field

The present disclosure relates to touch sensitive electronic devices and, particularly, to an electronic device having a touch panel with two touch areas having different touch sensitivity.

2. Description of Related Art

Touch sensitive electronic devices have become popular. Usually, different positions of the touch panel of a touch sensitive electronic device have the same sensitivity. Although the touch panels satisfy basic requirements, there remains a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic planar view of a touch sensitive electronic device in accordance with an exemplary embodiment.

FIG. 2 is a schematic side view of the touch sensitive electronic device of FIG. 1.

FIG. 3 is schematic planar view of a touch panel of the touch sensitive electronic device of FIG. 1.

FIG. 4 is schematic side view of a touch sensitive electronic device in accordance with another embodiment.

### DETAILED DESCRIPTION

Embodiments of the present disclosure will now be described in detail below, with reference to the accompanying drawings.

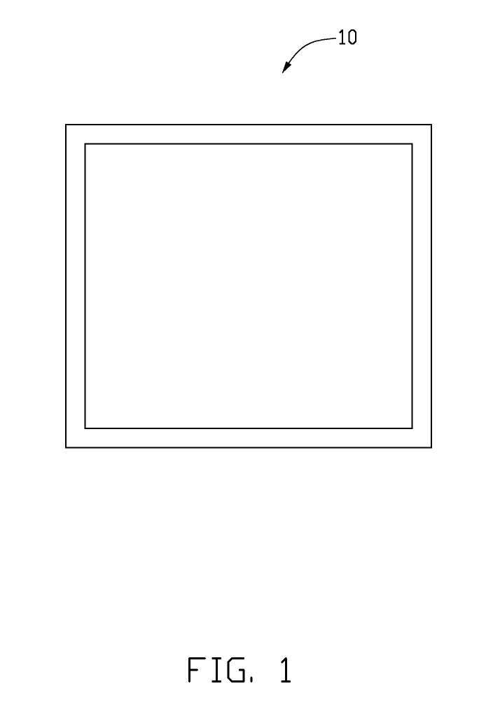

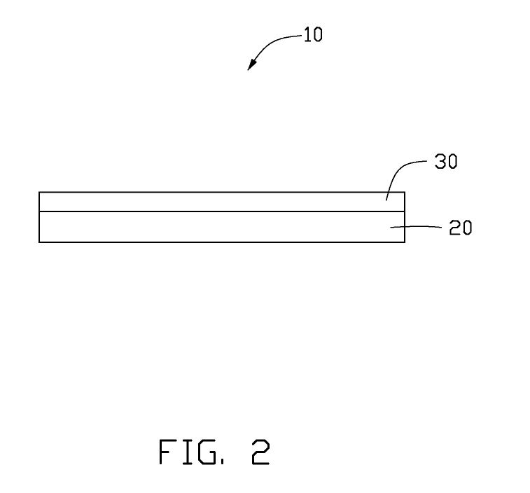

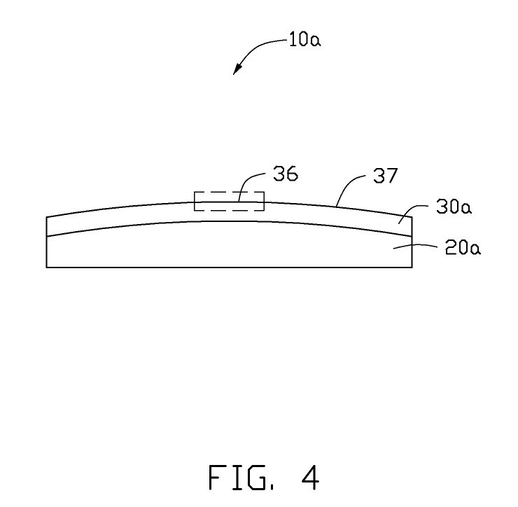

Referring to FIGS. 1 and 2, a touch sensitive electronic device 10 includes an LCD panel 20 and a touch panel 30 arranged on the LCD panel 20. The LCD panel 20 may have a flat viewing surface or a convex viewing surface (FIG. 4) used to display information.

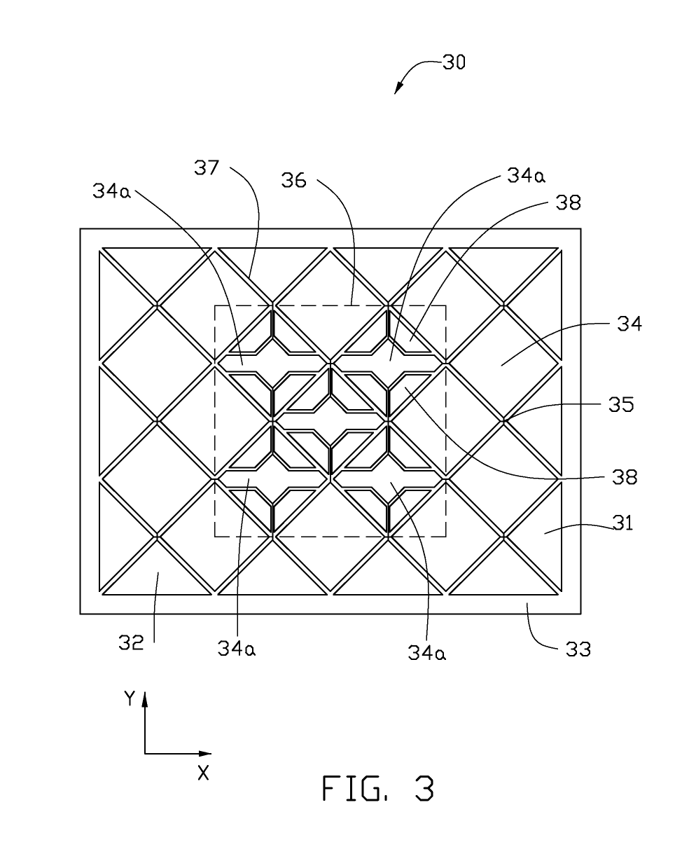

Referring to FIG. 3, the touch panel 30 is a capacitive touch sensitive panel, and includes a number of first electrodes 31 arranged along X axis in parallel with each other, and a number of second electrodes 32 arranged along Y axis in parallel with each other. A transparent layer separates the first electrodes 31 and the second electrodes 32, so that they intersect with each other, but do not contact with each other. The touch panel 30 of this embodiment detects a change in capacitance of those first electrodes 31 and second electrodes 32 to calculate a position where the touch panel 30 has been touched.

The first electrodes 31 and the second electrodes 31 can be made of transparent indium tin oxide (ITO). Both of the first electrodes 31 and the second electrodes 31 include a number of electrode portions 34 that are connected together by connection portions 35. The touch panel 30 includes a first touch area 36 and a second touch area 37.

When a finger touches the touch panel 30, a coupling capacitance between the first electrodes 31 and the second electrodes 32 adjacent to the touch position will change. An index of the detection sensitivity of the touch panel 30 is the ratio of a change in capacitance that is caused by a touch of a finger to background noise (hereinafter referred to as SN ratio). To increase the detection sensitivity, i.e., the SN ratio, it requires increasing signals or reducing noise.

The signal level is in proportion to the capacitance that is formed between a finger touching the touch panel 30 and an electrode 31 or 32. A fact found about background noise is that the fluctuations in voltage of a signal generated by the LCD panel 20 in order to display information are detected as noise by electrodes 31 or 32. It is easier to detect the noise when the area of the electrode 31 or 32 is larger because the ground capacitance is accordingly larger.

In the embodiment, within the first touch area 36 of the touch panel 30, the area of each electrode portions 34a is smaller than each electrode portion 34 within the second touch area 37. Thus, the first touch area 36 has less background noise than the second touch area 37. A number of floating electrodes 38 are arranged around each electrode portions 34a. Each electrode portions 34a and its corresponding floating electrodes 38 cooperatively form a shape substantially the same as the electrode portion 34. As such, when first touch area 36 and the second touch area 37 are touched, the capacitance formed between the finger and the touch panel 30 can be substantially the same. With such structure, the first touch area 31 has a larger SN ratio than the second touch area 32, in other words, the first touch area 31 has a larger sensitivity than the second touch area 32.

Referring to FIG. 4, a touch sensitive electronic device 10a, which includes an LCD panel 20a having a convex viewing surface, is illustrated. The touch area 36 of a touch panel 30a surrounds the central portion of the viewing surface of the LCD panel 20a, and the touch area 37 surrounds the touch area 36. With higher touch sensitivity, the touch area 36 can function more reactive and will not be affected by the convex shape of the LCD panel 20a.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A touch sensitive electronic device comprising:
an LCD panel; and
a touch panel arranged over the LCD panel and comprising a first touch area and a second touch area, wherein the first touch area and the second touch area have different touch sensitivity.

2. The touch sensitive electronic device according to claim 1, wherein the LCD panel comprises a convex viewing surface, the first touch area covers a central portion of the convex viewing surface, the second touch area surrounds the first touch area.

3. The touch sensitive electronic device according to claim 1, wherein the touch panel is a capacitive touch sensitive screen.

4. The touch sensitive electronic device according to claim 1, wherein the touch panel comprises a plurality of first electrodes and a plurality of second electrodes that are respectively arranged along a first axis and a second axis.

5. The touch sensitive electronic device according to claim 4, wherein each of the plurality of first electrodes and the plurality of second electrodes comprises a plurality of electrode portions and a plurality of connection portions that are used to connect the electrode portions together.

6. The touch sensitive electronic device according to claim 5, wherein the area of each electrode portion within the first touch area is smaller than each electrode portion within the second touch area.

7. The touch sensitive electronic device according to claim 5, wherein a plurality of floating electrodes are arranged around each electrode portion within the first touch area, the plurality of floating electrodes and the corresponding electrode portion within the first touch area cooperatively form a shape substantially the same as the electrode portion within the second touch area.
